(19) United States
(12) Patent Application Publication
(10) Pub. No.: US 2013/0239146 A1
(43) Pub. Date: Sep. 12, 2013

(54) User Interface for Television Programming and Social Media Feeds for Time Shifted Viewing

(71) Applicant: AEREO, INC., Long Island City, NY (US)

(72) Inventors: William Griffin Cherry, Roslindale, MA (US); Chaitanya Kanojia, West Newton, MA (US)

(73) Assignee: AEREO, INC., Long Island City, NY (US)

(21) Appl. No.: 13/752,719

(22) Filed: Jan. 29, 2013

Related U.S. Application Data
(60) Provisional application No. 61/607,208, filed on Mar. 6, 2012.

(51) Int. Cl. H04N 21/482

(52) U.S. Cl. CPC H04N 21/482
USPC 725/43

(57) ABSTRACT

A Graphical User Interface (GUI) for displaying broadcast television on a mobile device. The GUI is intended for use with a cloud-based digital video recorder and includes a programming guide, allowing users to watch live television or record programs for later viewing. The invention also includes a system for displaying comments about television programs in a social networking environment. The comments are entered and distributed relative to a particular point in a television program rather than in real time, allowing users to comment on a television program even when they are not watching the program at the same time.

### RELATED APPLICATIONS

This application claims the benefit under 35 U.S.C. §119(e) of U.S. Provisional Application No. 61/607,208, filed on Mar. 6, 2012, which is incorporated herein by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Over the air television, which is also referred to as terrestrial television or broadcast television, is a distribution mode for television programming via radio waves through the atmosphere. Some examples of well-known major television networks in the United States that broadcast over the air content are ABC, CBS, FOX, NBC, and PBS. Through a series of affiliate stations, these networks are able to blanket the country with broadcasted content. The result is that each one of these television networks is able to reach over 95% of all the households in the United States.

Many websites are available that also present television programs. Broadcast television networks make some of their programming available online for people to access via the Internet. Typically, television networks will upload content to their website or some other third party website, such as HULU, that is typically permitted to show the content a day or two after the show has aired. Other websites, such as Netflix, are subscription based, and historically offer television programs and movies that have already been released on DVD.

Digital Video Recorder (DVR) technology is used to record and playback television programming. The DVR records video in digital format to a hard drive and allows users to access the recorded video for later viewing. DVR technology has several advantages. It allows a user to record a television program and watch it at his or her convenience, rather than when the program is broadcast. It also allows users to fast forward and rewind to particular points in the program and to pause the program, for example, if something else requires their attention. Examples of video sources recordable by DVRs include cable, satellite and broadcast television. Broadcast television is broadcast in digital format that can be directly recorded by the DVR without any required decryption or decoding, as can be required with satellite and cable television.

Traditionally it was required that the broadcast signal first be received by a television antenna and then transmitted to a DVR physically linked to the television. However, recently a cloud-based DVR has been developed that allow users to receive live or pre-recorded broadcast television on any internet-enabled video display device.

A wide variety of options for viewing video content accessed via the internet now exist. In addition to internet-enabled televisions, personal computers, and laptop computers, many now watch video on their smartphones and other mobile computing devices such as tablet or slate computers. Video content is usually accessed through the Internet using subscriber data networks, cellular phone networks, and public and private wireless data networks. Moreover, many users are highly mobile. It is common for a person to travel to various locations with their personal computers, mobile phone, and/or other electronic computing devices and be able to access the Internet or a cellular phone network wherever they are located.

Many of these internet-enabled video display devices are also used for other internet-based functions, such as accessing social networking websites. A social networking site is a web-based online community that allows a user to link with other users within their social network and interact with them via means such as shared content, e-mail and instant messaging, and group-directed messages.

Social networking sites often contain a social networking feed. Examples of well-known social networking sites that contain social networking feeds are Facebook, Google+, and LinkedIn. The social networking feed allows the user to see a list of real time updates about other linked users—often users within their network. For example, items posted in the feed may include comments entered by other users or messages about actions taken by other users. The social networking feed allows the user to quickly see a broad overview of the events within their network in a single location.

Given typical television daily viewing levels and the fact that many social interactions are taking place over the internet, technology has recently been developed to allow social television watching by connecting viewers over the internet. For example, Netflix at one time offered a feature called “Party Watch” when run on the Xbox gaming console. This allows users in distinct locations to watch a television program and at the same time and carry on a conversation using headsets. SplashCast enables users to integrate the social networking component of websites such as Facebook and MySpace with video viewing sites such as HULU.

### SUMMARY OF THE INVENTION

Over the air content provided by broadcast television networks is available through cable television subscriptions or by capturing the over the air broadcasts. This captured content has traditionally only available for display on a television. Various websites enable the viewing of television programs on internet-enabled video display devices such as internet enabled televisions, personal computers, or mobile computing devices, but these television programs are pre-recorded and often limited in selection. Furthermore, options for watching television in a social networking environment over the internet are limited. Some options only allow users to communicate via voice and all pertain to watching pre-recorded programs that must be watched synchronously.

The present invention concerns a Graphical User Interface (GUI) for displaying live and previously recorded broadcast television of a cloud-based video delivery system on a video display device capable of displaying the GUI with a selectable portion in addition to a video portion. Users are able to select broadcast television programs from a programming guide for immediate viewing or for recording and viewing at a later point.

According to another aspect, the present invention also integrates an internet-based social networking environment with internet-based television viewing. Because the GUI combines web-based viewing with DVR technology, multiple linked users may watch the same television program, but at different times, if desired. The system enables comments entered by one user while viewing a television program to be displayed to a second user when the second user reaches the same point in the same program. In this way, users can post comments that are directly related to the content of the program.

The invention described herein can give the following advantages over prior systems: it can allow users to select broadcast television accessed via the internet for immediate viewing or recording on a video display device and, within an internet-based social networking environment, it can enable user comments to be displayed synchronously with a particular television program rather than in real time.

In general according to one aspect, the invention features a graphical user interface provided by a cloud based video delivery system comprising a video portion in which pre-recorded or live broadcast television programs are displayed and at least one sidebar adjacent to the video portion, including a programming guide sidebar displaying television programming.

In embodiments, the television programing is listed by broadcast time and broadcast network and is selectable for recording or for immediate viewing in the video portion. The programming guide sidebar can be searched by broadcast time. A series of screens is displayed in the video portion when television programs are not displayed, including a screen displaying a selectable list of television series and television programs selected by a user for recording. Pop-up windows are superimposed on the screen listing television programs selectable for recording or viewing.

Preferably, a social networking feed is displayed as a sidebar, for example, for displaying comments and actions of linked users within a social networking environment. The feed can further display notifications regarding scheduled recordings of television programs, upcoming television programs, and amount of digital video recorder space available.

In general according to another aspect, the invention features a method for controlling video using a graphical user interface provided by a cloud based video delivery system. The method comprises displaying pre-recorded or live broadcast television programs in a video portion of the graphical user interface and displaying at least one sidebar adjacent to the video portion, including a programming guide sidebar displaying television programming.

In general according to another aspect, the invention features a system for distributing synchronized social networking comments for television programs. The system comprises a series of devices asynchronously displaying the television programs on a series of screens, the devices receiving comments entered by users at time points in the running of each of the television programs, the devices displaying previously-entered comments on the screens based on time points in running of the same television programs that the comments were entered for the other linked users, and a social media server for enabling the distribution of the comments between the devices.

In general according to another aspect, the invention features a method for distributing synchronized social networking comments for television programs. The method comprises asynchronously displaying television programs on a series of screens of devices, the devices receiving comments entered by users at time points in the running of each of the television programs. Previously-entered comments are displayed on the screens based on time points in running of the same television programs that the comments were entered for the other linked users.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating the interrelation of the users, the video display devices, the site for supplying video, and the social media server.

FIG. 2 is a screen shot illustrating the graphical user interface (GUI) with the programming guide sidebar.

FIG. 3 is a screen shot illustrating the GUI with the programming guide sidebar in which a program has been selected.

FIG. 4 is a screen shot illustrating the GUI with the programming guide sidebar allowing the user to search by broadcast time.

FIG. 5 is a screen shot illustrating the GUI with the social networking feed sidebar and a screen displaying a selectable list of television series and television programs.

FIG. 6 is a screen shot illustrating the GUI with the social networking feed sidebar wherein a television series from the selectable list of television series and television programs has been selected.

FIG. 7 is a screen shot illustrating the GUI with the social networking feed sidebar wherein a television program from a list of recorded television programs of a television series has been selected.

FIG. 8 is a timeline illustrating the synchronizing of comments by users with a television program.

### DETAILED DESCRIPTION OF THE PREFERRED EMBODIMENTS

The invention herein generally relates to a graphical user interface for recording and viewing broadcast television programs and a system for displaying social networking comments entered by users so that they are synchronized with a television program.

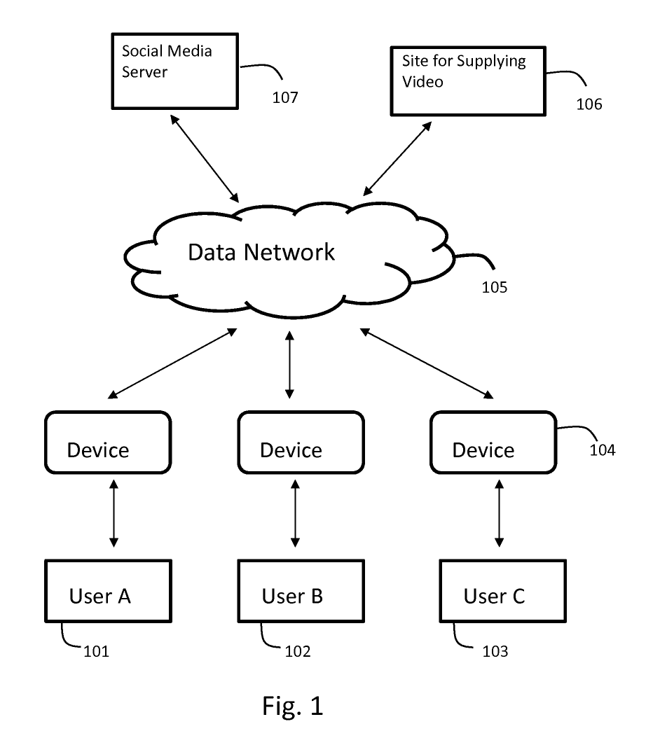

FIG. 1 shows users 101, 102, 103 interacting with a GUI that is displayed on video display devices such as internet enabled televisions, personal computers, or mobile computing devices 104. The GUI is displayed on the screen of the video display devices 104. The video display devices 104 are connected to a data network 105 such as the internet, private network and/or cellular network. Via this connection the video display devices 104 access video content via a site for supplying video 106 and social networking content via social media server 107 that generate the GUI that is displayed or rendered on the devices 104.

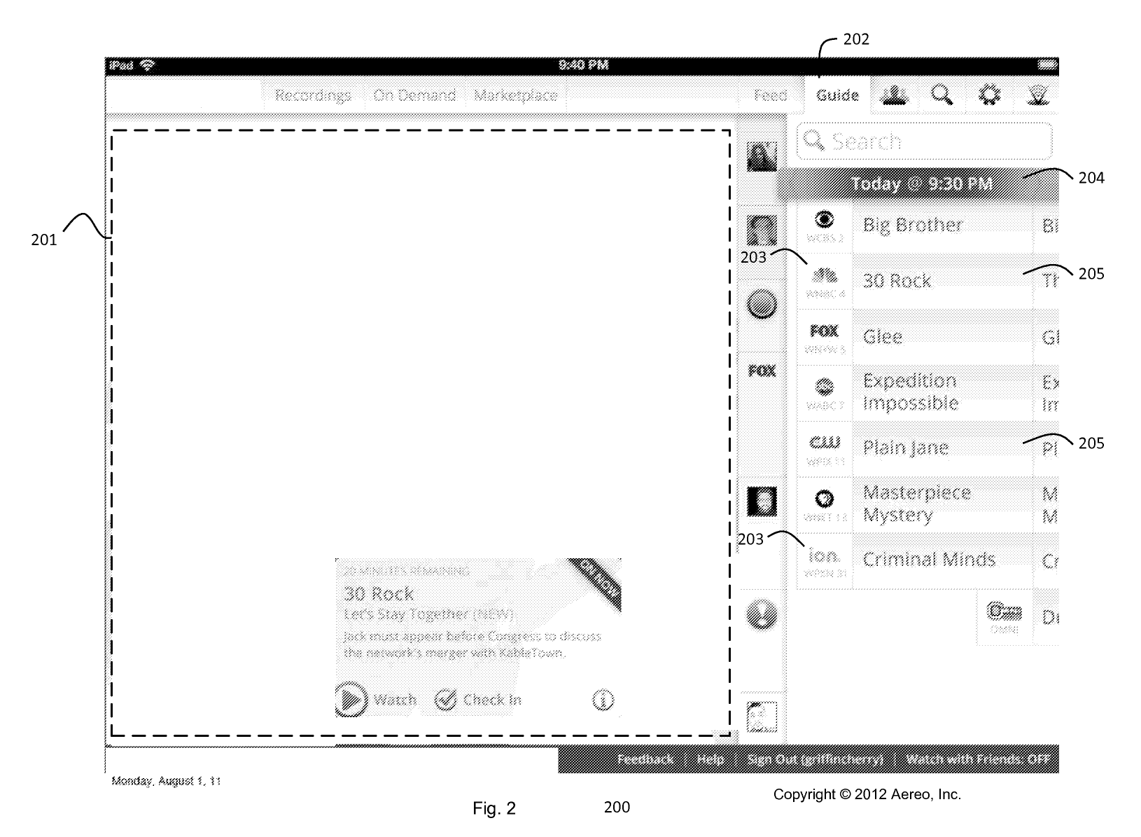

FIG. 2 shows the graphic user interface (GUI) that is served by the site 106 and displayed on the computing devices 104, which GUI has been constructed according to the principles of the present invention.

The GUI 200 includes a video portion 201 adjacent to a series of sidebars. The video portion displays live or broadcast television or video that is supplied via the data network 103. Programs displayed are selected from a schedule of broadcast television programming that is displayed on a programming guide sidebar 202. The schedule of broadcast television programming is presented as a list, wherein television programs 205 are arranged according to broadcast network 203 and broadcast time 204.

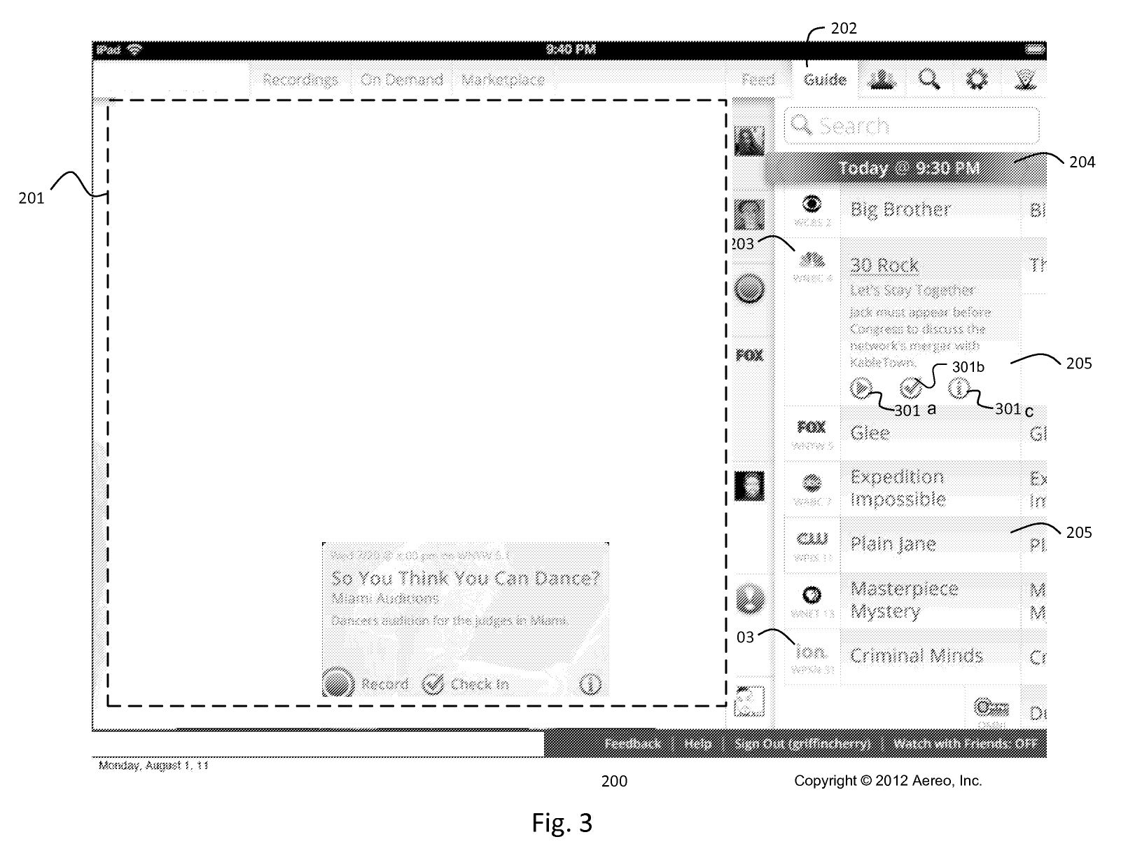

As shown in FIG. 3, when a television program 205 is selected from programming guide sidebar 202, the user is presented with additional information about the program and selectable links 301 that enable viewing a television program 301a presently being broadcast, recording 301b a future program, or displaying more information 301c about the program. Selecting to watch the program (301a) cause the programs video to be displayed in the video portion 201.

Selections are made by the user either through the use of a pointing device, such as a mouse, or optionally by physically touching the screen when the video display device 104 has a touchscreen, such as an iPad portable computing device.

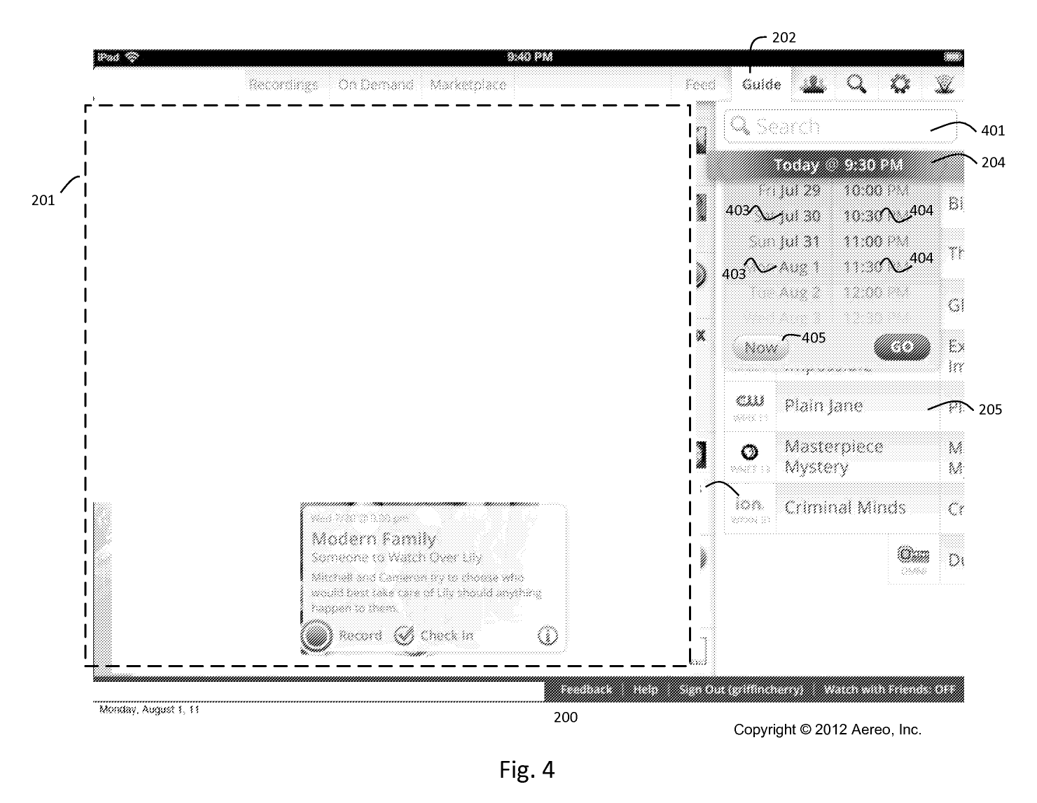

As shown in FIG. 4, the user is able to search for television programs in several ways. A search box 401 in programming guide sidebar 202 allows a user to search for television programs by terms entered. Further, by selecting the broadcast time 204 on the programming guide sidebar 202, a dropdown menu 402 appears allowing a user to select a specific date 403 and time 404 of television program information to display on the programming guide sidebar 202. Alternatively, the user has the option of viewing current program information by selecting the “now” button 405.

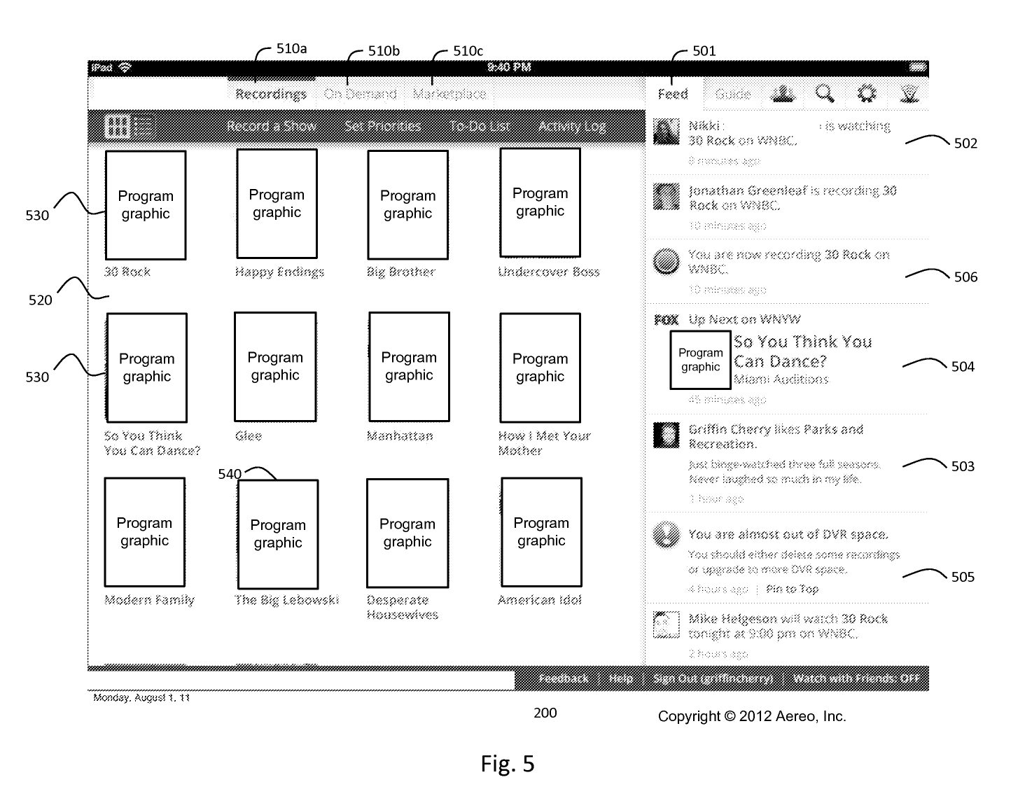

FIG. 5 shows the inclusion of a social networking feed 501 in the GUI 200. By displaying a social networking feed 501, the GUI 200 provides a socially interactive environment for watching television. The social networking feed 501 displays information supplied by social media server 107, posting information about other users to whom user is linked. Types of information that appear in this social networking feed 501 includes messages about television programs that other users are recording, watching, or planning to watch 502 in addition to comments posted by other users 503. In certain embodiments, in addition to posting information from the social media server 107, the social networking feed 501 also presents information from the site for supplying video 106, including notifications about upcoming television programs and recordings 504, the amount of DVR space available 505, and programs currently being recorded 506.

The user can navigate between different screens by selecting identifying tabs 510a, 510b, 510c. The content of these screens allows the user to modify the television program recording settings and to select previously recorded television programs to view. One of these screens 520 displays a selectable list of television series 530 and other types of television programming, such as movies 540. Selection of one of the programs converts regions 520 into a video display region that displays the selected television program side-by-side with the social networking feed. Additionally, selecting the television program causes an update message to be sent by the video site 106 to the social media server 107, which updates the social networking feed of the user with the details of the selected television program. In this way, the user shares their program selection with their friends within the social networking site.

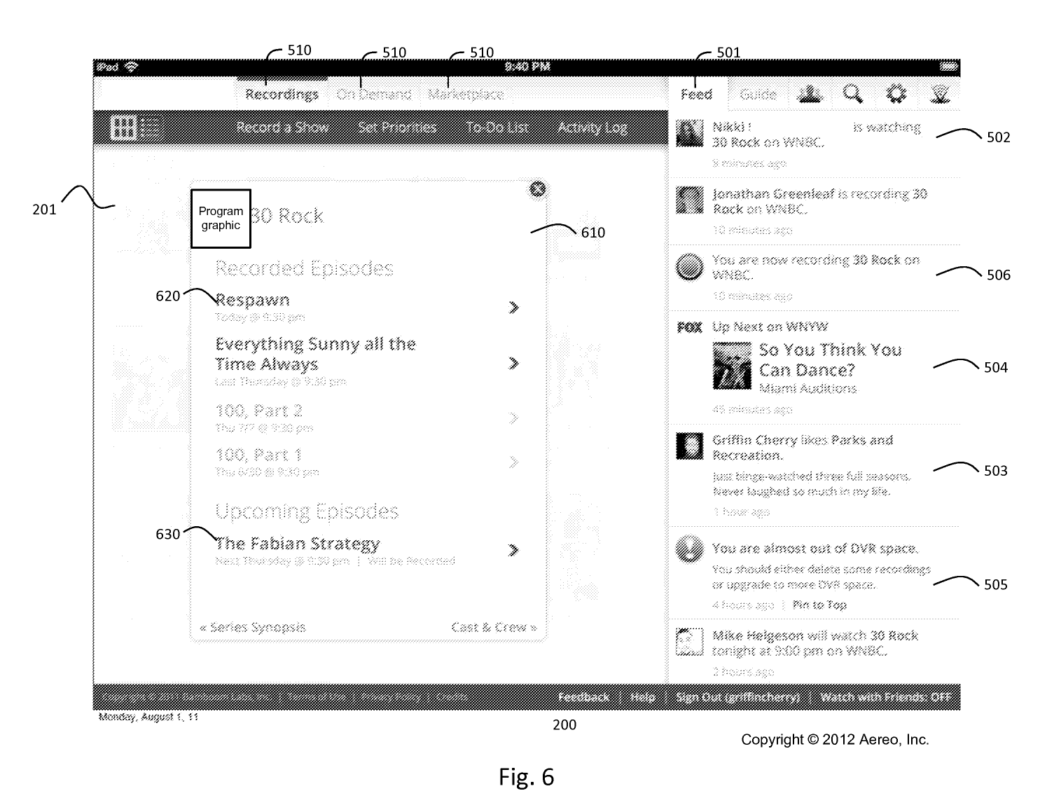

FIG. 6 demonstrates that upon selection of a television series 530 from screen 520, pop-up window 610 is displayed over the video presented in the video portion 201. Pop-up window 610 includes a list of previously recorded 620 and upcoming 630 episodes, or television programs of the television series 530. Clicking on an upcoming television program 630 will enable the user to view and modify the recording settings for the television program. The user's selection of a new program to record or a change in the record setting of an existing recording cause an update message to be sent by the video site 106 to the social media server 107, which updates the social networking feed of the user with the details of the recorded television program(s). In this way, the user shares their program recording selections with their friends within the social networking site.

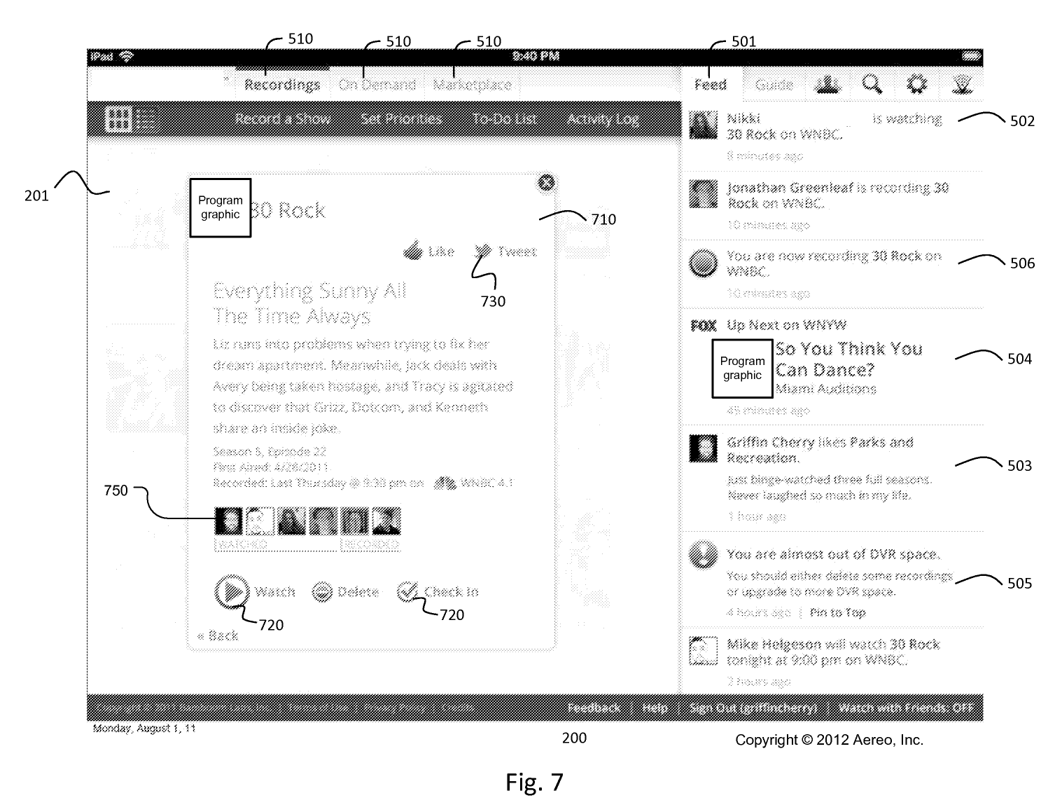

FIG. 7 demonstrates that upon selecting a previously recorded television program 620 from pop-up window 610, a second pop-up window 710 is displayed. In this window, the user is presented additional information about the television program 620 along with selectable links 720 allowing the user to watch or delete the previously recorded television program 620. This pop-up window 710 has social networking functions beyond what is presented in social networking feed 501, including displaying the linked users 750 that have watched and recorded the previously recorded television program 620 and presenting links 730 to enabling the user to interact with other social networking sites, for example Twitter. Here selection of the “watch” icon results in the display of the television program in video region 201.

The GUI 200 also allows for the posting social networking comments that are synchronized to a particular television program, in one embodiment. By enabling users to post comments about television programs and then having those comments displayed to other users at the same point in the running of the television program, a web-based social networking environment that incorporates television watching is created. Furthermore, by enabling user to make comments related to specific events within television programs and to have the comments viewed by other users only once they reach the same point in the running of the television program, users are free to comment on the content of television programs without being concerned about accidentally revealing the content to users who have not yet viewed, but will later view the program, timeshifted.

As is illustrated in FIG. 1, a series of video display devices 104 are connected to both the site for supplying video 106 and the social media server 107 via the network. Users 101, 102, 103 receive television programs on their video display devices 104. As the users 101, 102, 103 view the television programs, they post comments about the television programs. The comments are transmitted to the social media server 107 along a program counter or timestamp that indicated the position in the program when the user posted the comment. Each of the users 101, 102, 103 has a series of other users to which they are linked within a social networking environment. As other linked users 101, 102, 103 watch the same television program on their video display devices 104, comments that have been entered by linked users who previously watched the television program are displayed once they reach the same point in the running of the television program by social media server 107 by reference to the timestamps of those previous comments.

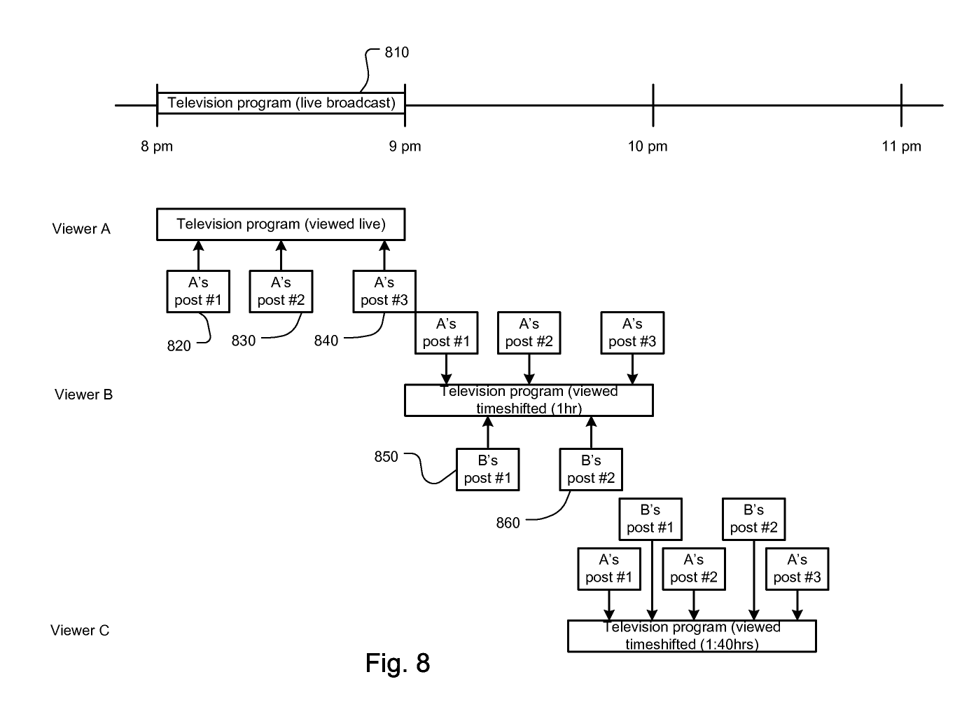

The function of the system is demonstrated in greater detail in FIG. 8. A television program 810 is viewed by 3 users, user A 101 user B 102 and user C 103. User A 101 watches the television program 810 live and makes three comment posts at three points during the program. User A's 101 post #1 820 is made near the beginning of television program 810. Post #2 830 is made near the middle of television program 810. Post #3 840 is made towards the end of television program 810. Each of these comment posts is received by the media server and stored along with its timestamp indicating when during the running of the program 810 the comment post was posted.

User B 102 then watches a recorded version of television program 810 1 hour after the live broadcast. The posts made by user A 101 are displayed to user B 102 at the same point in the television program that they were made by user A. For example, User A's 101 post #1 820 is displayed near the beginning of the pre-recorded version of television program 810 watched by user B 102 and an hour after post #1 820 was entered by User A 101. User B 102 also posts comments. User B's 102 post #1 850 is entered after User B 102 has viewed user A's 101 post #1 820 and before user B 102 has viewed user A's 101 post #2 830. User B's 102 post #2 860 is entered after User B 102 has viewed user A's 101 post #2 830 and before user B 102 has viewed user A's 101 post #3 840.

The result for a third user, user C 103, is that all of the posted comments will be displayed relative to the point in the television program 810 that they were posted rather than in real-time. If user C 103 watches a pre-recorded version of television program 810 1 hour and 40 minutes after the live broadcast, User A's 101 post #1 820, Post #2 830, and Post #3 840 will be displayed at the beginning, middle and end of the pre-recorded version of television program 810 watched by user C 103 respectively and 1 hour and 40 minutes after each comment was entered. User B's 102 post #1 850 will be displayed after user A's 101 post #1 820 and before A's 101 post #2 830. User B's 102 post #2 860 will be displayed after user A's 101 post #2 830 and before user A's 101 post #3 840. User B's 102 post #1 850 and post #2 860 will both be displayed 40 minutes after they were entered by User B 102.

While this invention has been particularly shown and described with references to preferred embodiments thereof, it will be understood by those skilled in the art that various changes in form and details may be made therein without departing from the scope of the invention encompassed by the appended claims.

What is claimed is:

1. A graphical user interface provided by a cloud based video delivery system comprising:
a video portion in which pre-recorded or live broadcast television programs are displayed; and
at least one sidebar adjacent to the video portion, including a programming guide sidebar displaying television programming.

2. The graphical user interface of claim 1, wherein the television programing is listed by broadcast time and broadcast network.

3. The graphical user interface of claim 1, wherein the television programing listed in the programming guide sidebar is selectable for recording or for immediate viewing in the video portion.

4. The graphical user interface of claim 1, wherein the schedule of broadcast television programming displayed in the programming guide sidebar can be searched by broadcast time.

5. The graphical user interface of claim 1, wherein a series of screens is displayed in the video portion when television programs are not displayed, including a screen displaying a selectable list of television series and television programs selected by a user for recording.

6. The graphical user interface of claim 5, wherein the screen further comprises pop-up windows superimposed on the screen listing television programs selectable for recording or viewing.

7. The graphical user interface of claim 1, further comprising pop-up windows superimposed on the screens displaying information on a television program and selectable links.

8. The graphical user interface of claim 1, further comprising a social networking feed for displaying comments and actions of linked users within a social networking environment.

9. The graphical user interface of claim 8, wherein the feed further displays notifications regarding scheduled recordings of television programs, upcoming television programs, and amount of digital video recorder space available.

10. The graphical user interface of claim 8, wherein the feed is displayed as a sidebar.

11. A method for controlling video using a graphical user interface provided by a cloud based video delivery system, the method comprising:
displaying pre-recorded or live broadcast television programs in a video portion of the graphical user interface; and
displaying at least one sidebar adjacent to the video portion, including a programming guide sidebar displaying television programming.

12. The method of claim 11, further comprising listing the television programing by broadcast time and broadcast network.

13. The method of claim 11, further comprising enabling the television programing listed in the programming guide sidebar to be selectable for recording or for immediate viewing in the video portion.

14. The method of claim 11, further comprising further comprising generating pop-up windows displaying information on a television program and selectable links.

15. The method of claim 11, further comprising displaying a social networking feed adjacent to the video portion for displaying comments and actions of linked users within a social networking environment.

16. The graphical user interface of claim 11, further comprising displaying in a feed notifications regarding scheduled recordings of television programs, upcoming television programs, and amount of digital video recorder space available.

17. A system for distributing synchronized social networking comments for television programs, the system comprising:
a series of devices asynchronously displaying the television programs on a series of screens, the devices receiving comments entered by users at time points in the running of each of the television programs; and
the devices displaying previously-entered comments on the screens based on time points in running of the same television programs that the comments were entered for the other linked users; and
a social media server for enabling the distribution of the comments between the devices.

18. A method for distributing synchronized social networking comments for television programs, the method comprising:
asynchronously displaying television programs on a series of screens of devices, the devices receiving comments entered by users at time points in the running of each of the television programs; and
displaying previously-entered comments on the screens based on time points in running of the same television programs that the comments were entered for the other linked users.
